(19) United States
(12) Patent Application Publication
(10) Pub. No.: US 2007/0229470 A1
(43) Pub. Date: Oct. 4, 2007

(54) Capacitive touch sense device having polygonal shaped sensor elements

(76) Inventors: Warren Snyder, Snohomish, WA (US); Ryan Seguine, Seattle, WA (US)

Correspondence Address: BLAKELY, SOKOLOFF, TAYLOR & ZAFMAN LLP, Seventh Floor, 12400 Wilshire Boulevard, Los Angeles, CA, 90025, US

(21) Appl. No.: 11/605,819

(22) Filed: Nov. 27, 2006

Related U.S. Application Data
(60) Provisional application No. 60/787,983, filed on Mar. 31, 2006.

(51) Int. Cl. G06F 3/041

(52) U.S. Cl. 345/173

(57) ABSTRACT

A touch sensor pad having polygon shaped sensor elements of five or more sides is described.

### RELATED APPLICATIONS

The present application claims the benefit of U.S. Provisional Application No. 60/787,983 filed Mar. 31, 2006, hereby incorporated by reference.

### TECHNICAL FIELD

This invention relates to the field of user interface devices and, in particular, to a capacitive touch sense device.

### BACKGROUND

Computing devices, such as notebook computers, personal data assistants (PDAs), and mobile handsets, have user interface devices, which are also known as human interface device (HID). One user interface device that has become more common is a touch-sensor pad. A basic notebook touch-sensor pad emulates the function of a personal computer (PC) mouse. A touch-sensor pad is typically embedded into a PC notebook for built-in portability. A touch-sensor pad replicates mouse x/y movement by using two defined axes which contain a collection of sensor elements that detect the position of a conductive object, such as a finger. Mouse right/left button clicks can be replicated by two mechanical buttons, located in the vicinity of the touchpad, or by tapping commands on the touch-sensor pad itself. The touch-sensor pad provides a user interface device for performing such functions as positioning a pointer, or selecting an item on a display. These touch-sensor pads may include multi-dimensional sensor arrays for detecting movement in multiple axes. The sensor array may include a one-dimensional sensor array, detecting movement in one axis. The sensor array may also be two dimensional, detecting movements in two axes.

A touch-sensor pad includes a sensing surface having sensing elements (also referred to as electrodes) on which a conductive object may be used to position a pointer in the x- and y-axes. A consideration in the construct of a touch-sensor pad is the use of as much of the pad area as possible, since unfilled pad is wasted while sensing. One conventional shape for a sensor electrode that is suitable for increasing surface area of a pad is a circle. However, circular shaped electrodes do not efficiently fill a sensor pad area. Some conventional touch sensor pads employ diamond shaped electrodes or triangular shaped electrodes, as illustrated in FIG. 1 and FIG. 2 respectively, that have increased edge capacitance (represented conceptually by the capacitors between the triangle shaped electrodes in expanded view of FIG. 2) and decreased the sensor pad area. A decreased sensor pad area reduces the amount of copper or other conductive material with which an activating element, such as a finger, can make contact. Increased edge capacitance adds parasitic capacitance to the system and decreases the proportional change in capacitance when an activating element, such as a finger, comes in contact with the sensing area.

Other shaped electrodes have also been described in references, such as U.S. Patent Application Publication 2006/0097991. More specifically, U.S. Patent Application Publication describes that electrodes may be formed from simple shapes (e.g., squares, circles, ovals, triangles, rectangles, polygons, and the like) or complex shapes (e.g., random shapes). U.S. Patent Application Publication states that the shapes of the electrodes are generally chosen to maximize the sensing area and, in the case of transparent electrodes, minimize optical differences between the gaps and the transparent electrodes.

### BRIEF DESCRIPTION OF THE DRAWINGS

The present invention is illustrated by way of example, and not by way of limitation, in the figures of the accompanying drawings.

FIG. 1A illustrates a conventional touch-sensor pad having diamond shaped electrodes.

FIG. 2 illustrates another conventional touch-sensor pad having triangular shaped electrodes.

FIG. 3A illustrates how a conductive object may affect the capacitance of a capacitive touch-sensing sensor element.

FIG. 3B is a conceptual cross-section view of the capacitive sensor element 300 of FIG. 3A.

FIG. 4A illustrates hexagonal shaped adjacent sensor elements within a sensor array according to one embodiment of the present invention.

FIG. 4B illustrates two embodiments of the gaps between hexagonal and octagonal shaped sensor elements.

FIG. 5A illustrates a top-side view of one embodiment of a sensor array having a plurality of hexagonal shaped sensor elements for detecting a presence of a conductive object on the sensor array.

FIG. 5B illustrates a block diagram of one embodiment of a capacitive sensor coupled to the sensor array of FIG. 5A.

FIG. 5C illustrates a top-side view of one embodiment of a two-layer touch-sensor pad

FIG. 5D illustrates a cross section view of one embodiment of the two-layer touch-sensor pad of FIG. 5C.

FIG. 6 is a cross-sectional view illustrating a non-planar touch sensor pad according to an alternative embodiment of the present invention.

FIG. 7 is a perspective view illustrating a dome-shaped touch sensor pad.

FIG. 8 is a two dimensional view illustrating the sensor elements of the dome-shaped touch sensor pad of FIG. 7 according to one embodiment of the present invention.

FIG. 9 illustrates a block diagram of one embodiment of an electronic system having a processing device and touch-sensor pad for detecting a presence of a conductive object according to one embodiment of the present invention.

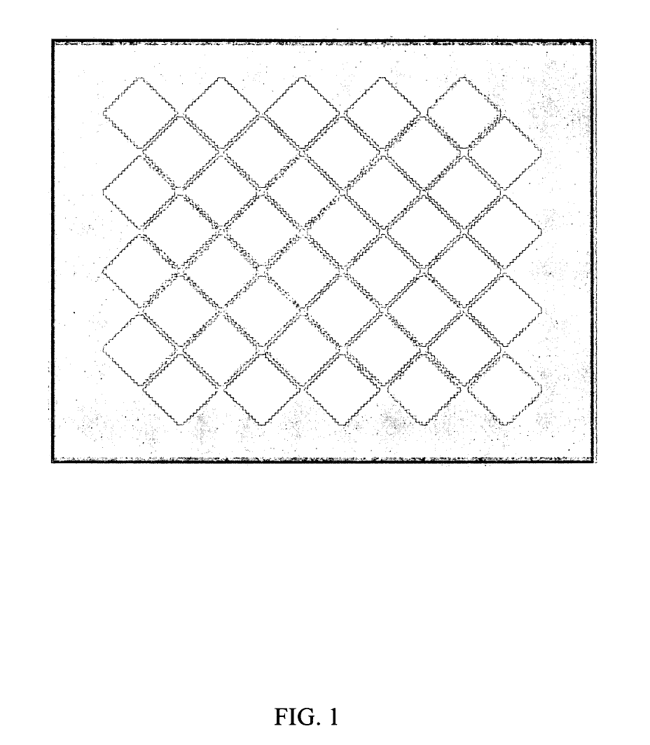

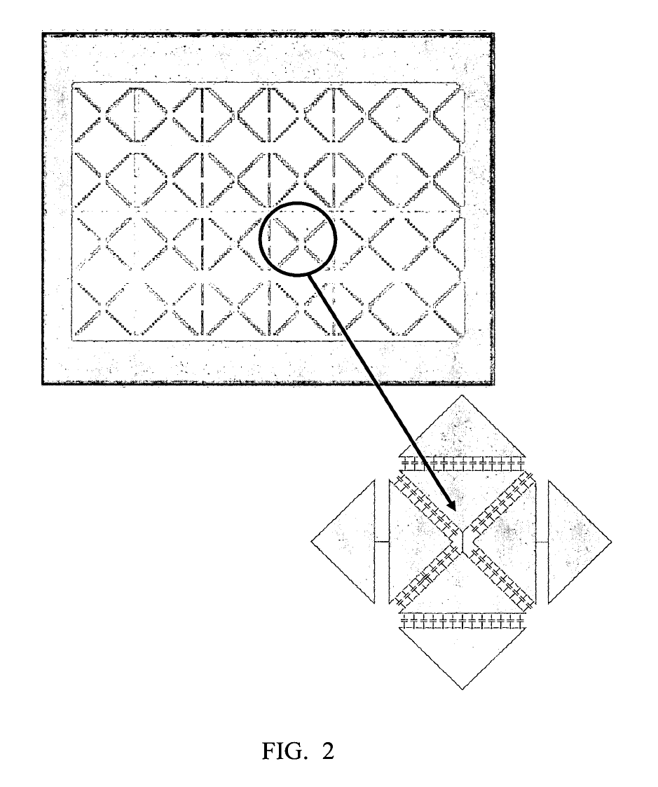

### DETAILED DESCRIPTION

Described herein is a method and apparatus for reducing charge time, and power consumption of sensor elements of a sensing device, such as a touch-sensor pad, touch-sensor slider, or a touch-sensor button. The following description sets forth numerous specific details such as examples of specific systems, components, methods, and so forth, in order to provide a good understanding of several embodiments of the present invention. It will be apparent to one skilled in the art, however, that at least some embodiments of the present invention may be practiced without these specific details. In other instances, well-known components or methods are not described in detail or are presented in simple block diagram format in order to avoid unnecessarily obscuring the present invention. Thus, the specific details set forth are merely exemplary. Particular implementations may vary from these exemplary details and still be contemplated to be within the spirit and scope of the present invention.

A touch sensor device having polygonal shaped sensor elements having five or more sides is described. The five or more sided polygonal shaped sensor elements of the touch sensor device may increase sensing element surface area while decreasing edge capacitance to yield greater packing efficiency and greater proportional capacitance change by an activating element. A decreased sensor area reduces the amount of copper or other conductive material with which an activating conductive object, such as a finger, can make contact. Increased edge capacitance adds parasitic capacitance to the device and decreases the proportional change in capacitance when an activating object, such as a finger, comes in contact with the sensing area.

In one embodiment, the touch sensor device has hexagonal shaped sensor elements that operate as capacitive sensor elements. The hexagonal shape of the sensor elements increases the vertical capacitance of each of the sensor elements to the conductive object while not increasing the fringe, horizontal, capacitance of the sensor elements to each other, as is described in further detail below. The vertical capacitance is represented in the following equation:

$${C}_{vertical} = \frac{{A}_{sensor} {ɛ}_{overlay}}{{d}_{vertical}} \qquad ( 1 )$$

The ratio of perimeter to area is given by the following equations for each of the following shapes:

$$\begin{matrix}Diamond \text{/} Square \text{:} \frac{A}{P} = \frac{x}{4} & ( 2 ) \\ Pentagon \text{:} \frac{A}{P} = \frac{x}{4 sin ( \frac{π}{5} )} & ( 3 ) \\ Hexagon \text{:} \frac{A}{P} = \frac{2 {x}^{2} + \frac{{x}^{2} \sqrt{3}}{4}}{6 x} & ( 4 ) \\ Heptagon \text{:} \frac{A}{P} = \frac{x}{4 sin ( \frac{π}{7} )} & ( 5 ) \\ Octagon \text{:} \frac{A}{P} = \frac{7 x}{8} & ( 6 )\end{matrix}$$

where x is a unit of measurement.
The fringe capacitance (without proportions) is given by:

$$\begin{matrix}{C}_{fringe} = \frac{{A}_{edge} {ɛ}_{substrate ( air )}}{{d}_{trace}} \\ where \text{:} & ( 7 ) \\ {A}_{edge} = P ( h ) & ( 8 )\end{matrix}$$

where h is the thickness of the sensor element.

As described above, the hexagonal shape of the sensor elements increases the vertical capacitance of each of the sensor elements to the conductive object while not increasing the fringe, horizontal, capacitance. Similarly, the pentagon shape of the sensor element increases the vertical capacitance while not increasing the fringe capacitance. For example, with a unit area of 1, a square or diamond has an area given by:

A=x², where x=1. (9)

Therefore, the perimeter of the square or diamond is given by:

P=4x, where x=1. (10)

### Assuming a unit area of 1, the perimeter of the square or diamond is 4, resulting in an area to perimeter ratio of 0.250.

In comparison, with a unit area of 1, a pentagon has an area given by:

$$A = \frac{{x}^{2}}{4} \cdot \sqrt{25 + 10 \sqrt{5}} , where x = 0.76 . \qquad ( 11 )$$

Therefore, the perimeter of the pentagon is given by:

P=5x, where x=0.76. (12)

Assuming a unit area of 1, the perimeter of the pentagon is 3.81, resulting in an area to perimeter ratio 0.262. Also, with a unit area of 1, a hexagon has an area given by:

$$A = ( \frac{3 \sqrt{3}}{2} ) x , where x = 0.62 . \qquad ( 13 )$$

Therefore, the perimeter of the hexagon is given by:

P=6x, where x=0.62. (14)

Assuming a unit area of 1, the perimeter of the hexagon is 3.72, resulting in an area to perimeter ratio 0.270. Accordingly, the area to perimeter ratio of the hexagon and pentagon are lower than the area to perimeter ratio of the square or diamond. This change in ratio increases the vertical capacitance measured on a sensor element. For example, the capacitance variation measured on the sensor element may be as little as 0.1% of the parasitic capacitance of the sensor element, so by increasing the vertical capacitance while not increasing the fringe capacitance, the capacitance variation when a conductive object is present on the device may be a easier to detect and measure. As described above, the capacitance is directly proportional to area. Since the capacitance is directly proportional to area, an increase in the perimeter acts like an increase in area along the cross section by adding to one dimension. So increasing the perimeter increases the fringe capacitance, and increasing the area of the sensor element increases the signal capacitance.

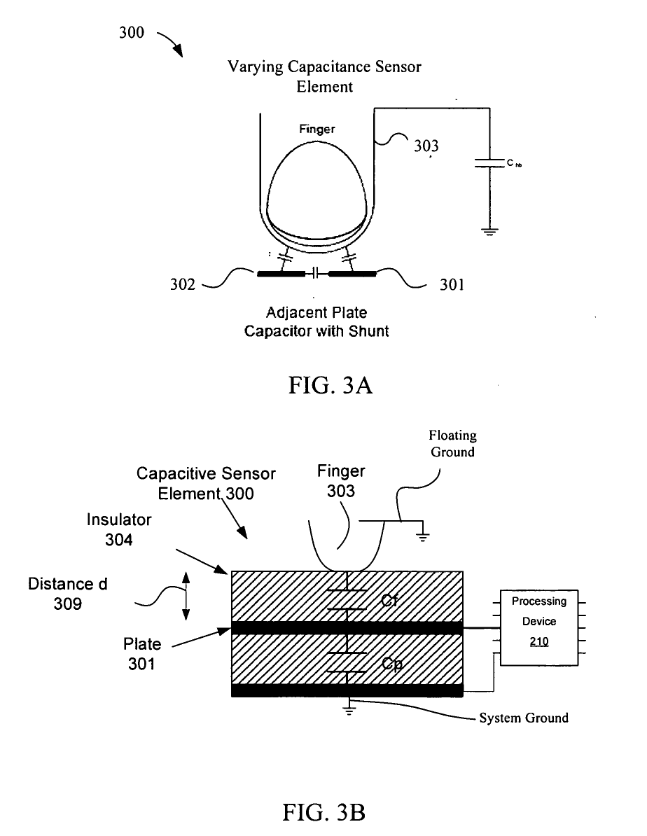

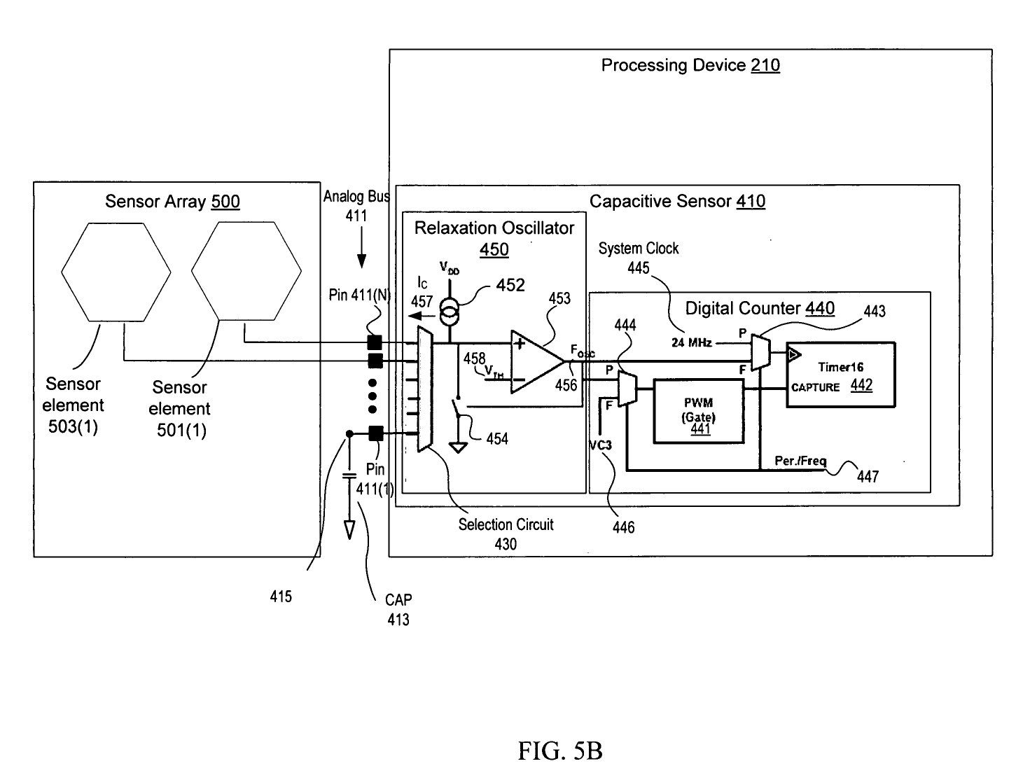

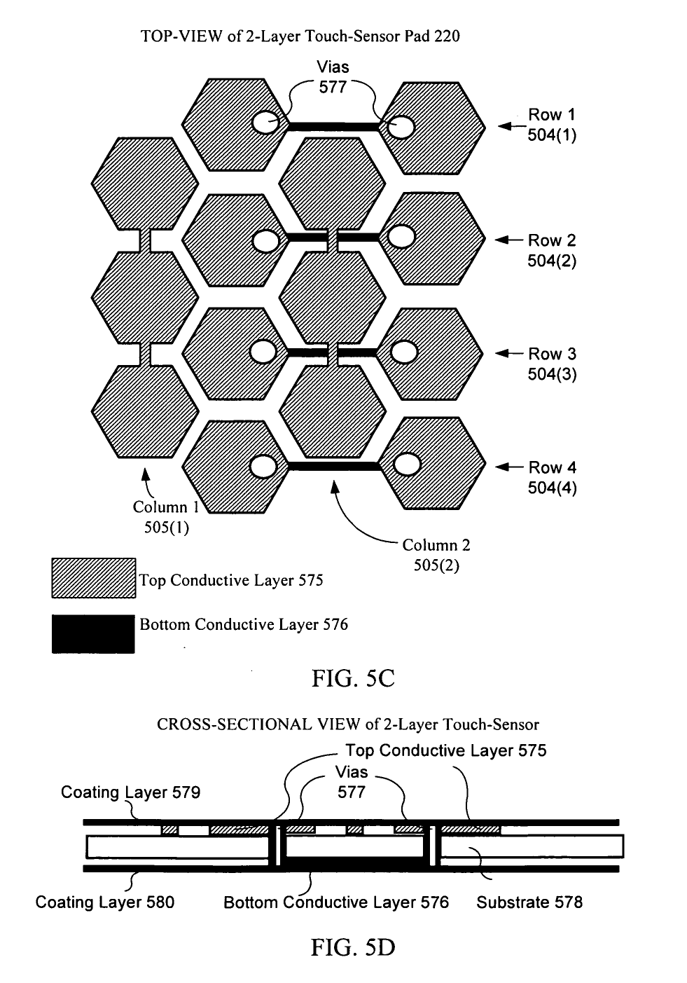

FIG. 3A illustrates how a conductive object may affect the capacitance of a capacitive touch-sensing sensor element. The conductive object in one embodiment is a finger. Alternatively, this technique may be applied to any conductive object, for example, a stylus. In its basic form, a capacitive sensor element 300 is a pair of adjacent plates (electrodes) 301 and 302. There is a small edge-to-edge capacitance Cₚ, but the intent of sensor element layout is to minimize the base capacitance Cₚ between these plates. When a conductive object 303 (e.g., a finger) is placed in proximity to the two plates 301 and 302, there is a vertical capacitance between one electrode 301 and the conductive object 303 and a similar vertical capacitance between the conductive object 303 and the other electrode 302. The vertical capacitance between electrode 301 and the conductive object 303 and the vertical capacitance between electrode 302 and the conductive object 303 add in series to yield a capacitance C_{F}. That capacitance adds in parallel to the base capacitance Cₚ between the plates 301 and 302, resulting in a change of capacitance C_{F} over the base capacitance. Capacitive sensor element 300 may be used in a capacitive sensor array where one electrode of each capacitor is grounded. Thus, the active capacitor (as conceptually represented in FIG. 5B as CAP 413) has only one accessible side. The presence of the conductive object 303 increases the capacitance (Cₚ+C_{F}) of the capacitive sensor element 300 to ground. Determining sensor element activation is then a matter of measuring the change in the capacitance (C_{F}) or capacitance variation. Capacitive sensor element 300 is also known as a grounded variable capacitor. In one exemplary embodiment, Cp may range from approximately 10-300 picofarads (pF), and Cf may be approximately between 0.5%-3.0% of Cp. Alternatively, Cf may be orders of magnitude smaller than Cp. Alternatively, other ranges and values may be used.

FIG. 3B is a conceptual cross-section view of the capacitive sensor element 300 of FIG. 3A. The capacitance generated by operation of capacitive sensor element 300 may be measured by a processing device 210, as will be discussed in greater detail below. As previously described, when a conductive object 303 (e.g., a finger) is placed in proximity to the conductive plates 301 and 302, there is an effective capacitance, C_{F}, between the plates and the conductive object 303 with respect to ground. Also, there is a capacitance, Cₚ, between the two conductive plates 301 and 302. Accordingly, the processing device 210 can measure the change in capacitance, capacitance variation C_{F}, when the conductive object is in proximity to the conductive plates 301 and 302. Above and below the conductive plate that is closest to the conductive object 303 is an insulating dielectric material 304. The dielectric material 304 above the conductive plate 301 can be the overlay, as described in more detail below. The overlay may be non-conductive material (e.g., plastic, glass, etc.) used to protect the circuitry from environmental conditions and to insulate the conductive object (e.g., the user's finger) from the circuitry. In one embodiment, the conductive plates 301 and 302 may have a hexagonal shape and are referred to as sensor elements, as discussed below.

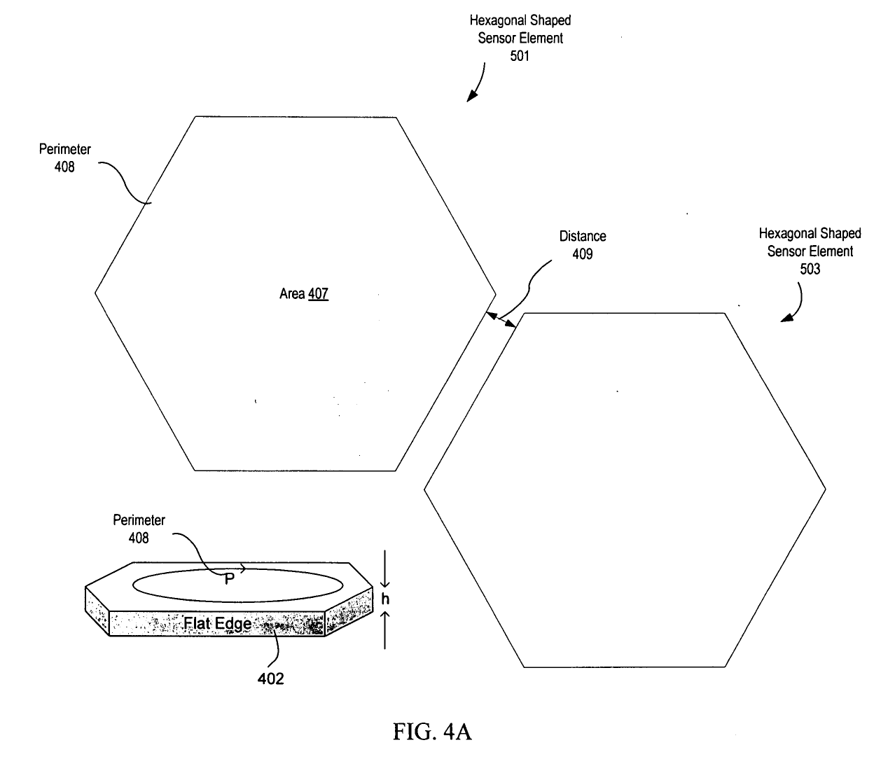

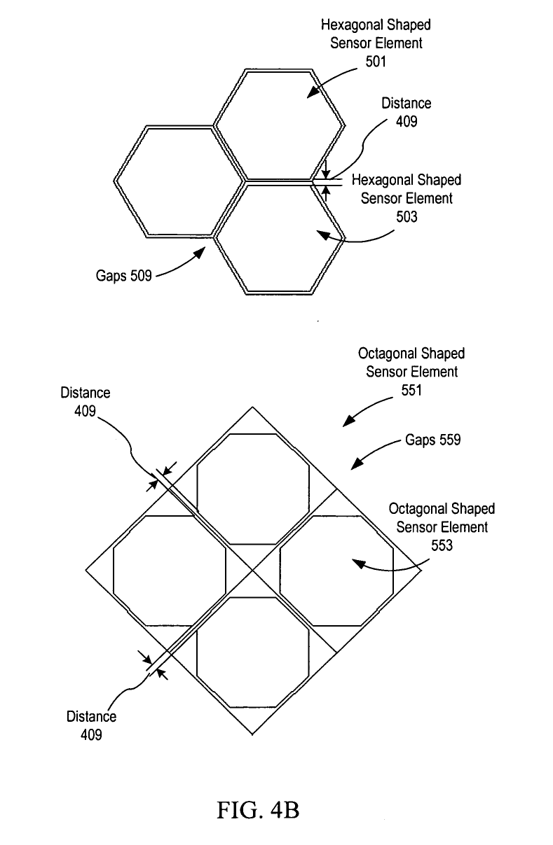

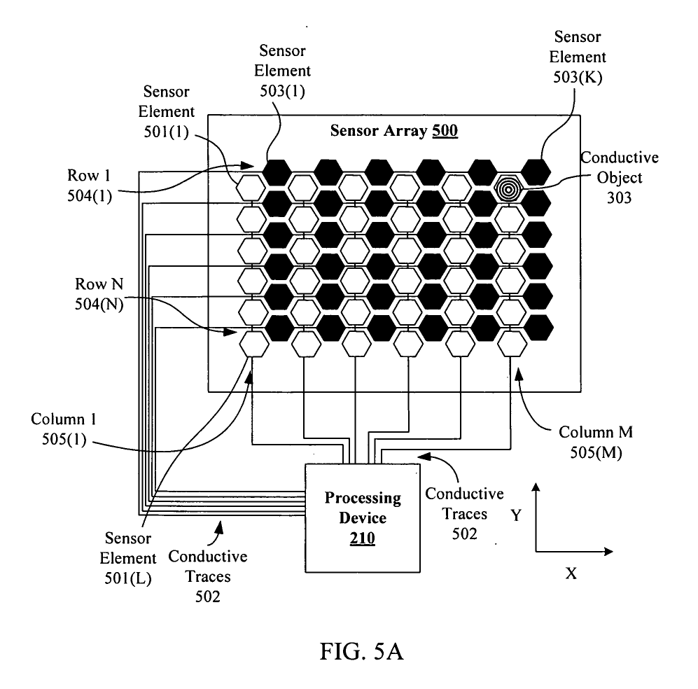

FIG. 4A illustrates hexagonal shaped adjacent sensor elements within a sensor array according to one embodiment of the present invention. In this embodiment, the shape of sensor elements 501 and 503 is substantially hexagonal. The use a hexagonal shape for the sensor elements 501 and 503 operates to increase the vertical capacitance of the conductive object (e.g., finger) by increasing the surface area 407 of the sensor elements as much as possible while reducing the amount of perimeter 408 of the sensor elements.

The vertical capacitance is equal to A∈/d (e.g., C=A∈/d). The vertical capacitance is, thus, based on three primary factors: the area (A) 407 of a sensor element, the distance (d) 309 (shown in FIG. 3B) between the conductive object and a sensor element (e.g., plate 301 or sensor element 501), and the dielectric properties (∈) of the insulator 304 between the conductive object and the sensor element (e.g., plate 301 or sensor element 501). In one embodiment, the distance (d) 309 between the conductive objection and the sensor element is determined by the thickness of insulator overlay 304, as illustrated in FIG. 3B. The dielectric properties (∈) of the overlay are substantially constant, with some minor changes with temperature. Accordingly, with larger area, the vertical capacitance to the finger increases.

The horizontal, or fringe capacitance, comes from the very thin edges of the conductive material (e.g., copper, ITO, etc.) that is used to form the sensor element (e.g., plate 302). There is a flat edge 402 and it has its own surface area and a distance 409 from an adjacent sensor element. The surface area of the flat edge is the height time the width of one side times the number of sides (6) of the sensor element. The use of a hexagonal shape for the sensor elements 501 and 503 increases the area 407 of each of the sensor elements while minimizing the perimeter 408 of each of the sensor elements (e.g., as opposed to an array having circular shaped sensor elements). Thereby, the vertical capacitance to the conductive object is increased while not increasing the horizontal, or fringe, capacitance to the other sensor elements in a sensor array as illustrated in FIG. 5A.

FIG. 4B illustrates two embodiments of the gaps between hexagonal and octagonal shaped sensor elements. Assuming a unit area and uniform spacing to a ground plane (or other sensor elements) for both the hexagonal and octagonal shaped sensor elements, each of the sides are 0.62 for the hexagonal shaped sensor elements 501 and 503 and 0.46 for the octagonal shaped sensor elements 551 and 553. The distance 409 between the sensor elements (501, 503, 551, and 553) is approximately 0.1 linear units. Gaps 509 and 559 are the area of the unit area of which there is no sensor element surface area (e.g., non-sensor area). The area of the gaps 509 that surround and are in between the hexagonal sensor elements is 0.19. The area of the gaps 559 that surround and are in between the octagonal sensor elements is 0.43. The area of the gap is given by the following equation:

A_{gap}=Aₜₒₜₐₗ−Aₛₑₙₛₒᵣ (15)

### Accordingly, the non-sensor area or gaps 559 of the octagonal sensor elements represents approximately 30% of the total unit area, and the non-sensor area or gaps 509 of the hexagonal sensor elements represent approximately 16% of the total unit area.

FIG. 5A illustrates a top-side view of one embodiment of a sensor array having a plurality of hexagonal shaped sensor elements for detecting a presence of a conductive object 303 on the sensor array 500. Alternating rows and columns in FIG. 5A correspond to, for example, x- and y-axis elements. The y-axis sensor elements 503(1)-503(K) are illustrated as black hexagons. The x-axis sensor elements 501(1)-501(L) are illustrated as white hexagons. Sensor array 500 includes a plurality of rows 504(1)-504(N) and a plurality of columns 505(1)-505(M), where N is a positive integer value representative of the number of rows and M is a positive integer value representative of the number of columns. Each row includes a plurality of sensor elements 503(1)-503(K), where K is a positive integer value representative of the number of sensor elements in the row. Each column includes a plurality of sensor elements 501(1)-501(L), where L is a positive integer value representative of the number of sensor elements in the column. Accordingly, sensor array is an N×M sensor matrix. The N×M sensor matrix, in conjunction with the processing device 210, is configured to detect a position of a presence of the conductive object 303 in the x-, and y-directions. In one embodiment, the sensor array is a 1×M or N×1 sensor matrix that can be configured to operate as a touch-sensor slider.

In one embodiment, the process device 210 may include a capacitive switch relaxation oscillator (CSR). It should be noted that there are various known methods for measuring capacitance. Although the embodiments described herein are described using a relaxation oscillator, the present embodiments are not limited to using relaxation oscillators, but may include other methods, such as current versus voltage phase shift measurement, resistor-capacitor charge timing, capacitive bridge divider, charge transfer, or the like. For example, the current versus voltage phase shift measurement may include driving the capacitance through a fixed-value resistor to yield voltage and current waveforms that are out of phase by a predictable amount. The drive frequency can be adjusted to keep the phase measurement in a readily measured range. The resistor-capacitor charge timing may include charging the capacitor through a fixed resistor and measuring timing on the voltage ramp. Small capacitor values may require very large resistors for reasonable timing. The capacitive bridge divider may include driving the capacitor under test through a fixed reference capacitor. The reference capacitor and the capacitor under test form a voltage divider. The voltage signal is recovered with a synchronous demodulator, which may be done in the processing device 210. The charge transfer may be conceptually similar to an R-C charging circuit. In this method, C_{P} is the capacitance being sensed. C_{SUM} is the summing capacitor, into which charge is transferred on successive cycles. At the start of the measurement cycle, the voltage on C_{SUM} is reset. The voltage on C_{SUM} increases exponentially (and only slightly) with each clock cycle. The time for this voltage to reach a specific threshold is measured with a counter. Additional details regarding these alternative embodiments have not been included so as to not obscure the present embodiments, and because these alternative embodiments for measuring capacitance are known by those of ordinary skill in the art.

FIG. 5B illustrates a block diagram of one embodiment of a capacitive sensor coupled to sensor array 500. It should be noted that only two sensor elements from sensor array 500 are shown in FIG. 5B for ease of illustration. Capacitive sensor 410 includes a relaxation oscillator 450, and a digital counter 440. The sensor array 500 is coupled to relaxation oscillator 450 via an analog bus 401 having a plurality of pins 401(1)-401(N). The multi-dimension sensor array 500 provides output data to the analog bus 401 of the processing device 210.

The selection circuit 430 is coupled to the plurality of sensor elements 355(1)-355(N), the reset switch 454, the current source 452, and the comparator 453. Selection circuit 430 may be used to allow the relaxation oscillator 450 to measure capacitance on multiple sensor elements (e.g., rows or columns). The selection circuit 430 may be configured to sequentially select a sensor element of the plurality of sensor elements to provide the charge current and to measure the capacitance of each sensor element. In one exemplary embodiment, the selection circuit 430 is a multiplexer array of the relaxation oscillator 450. Alternatively, selection circuit may be other circuitry outside the relaxation oscillator 450, or even outside the capacitive sensor 410 to select the sensor element to be measured. Capacitive sensor 410 may include one relaxation oscillator and digital counter for the plurality of sensor elements of the sensor array. Alternatively, capacitive sensor 410 may include multiple relaxation oscillators and digital counters to measure capacitance on the plurality of sensor elements of the sensor array. The multiplexer array may also be used to ground the sensor elements that are not being measured.

In another embodiment, the capacitive sensor 410 may be configured to simultaneously scan the sensor elements, as opposed to being configured to sequentially scan the sensor elements as described above. For example, the sensing device may include a sensor array having a plurality of rows and columns. The rows may be scanned simultaneously, and the columns may be scanned simultaneously.

In one exemplary embodiment, the voltages on all of the rows of the sensor array are simultaneously moved, while the voltages of the columns are held at a constant voltage, with the complete set of sampled points simultaneously giving a profile of the conductive object in a first dimension. Next, the voltages on all of the rows are held at a constant voltage, while the voltages on all the rows are simultaneously moved, to obtain a complete set of sampled points simultaneously giving a profile of the conductive object in the other dimension.

In another exemplary embodiment, the voltages on all of the rows of the sensor array are simultaneously moved in a positive direction, while the voltages of the columns are moved in a negative direction. Next, the voltages on all of the rows of the sensor array are simultaneously moved in a negative direction, while the voltages of the columns are moved in a positive direction. This technique doubles the effect of any transcapacitance between the two dimensions, or conversely, halves the effect of any parasitic capacitance to the ground. In both methods, the capacitive information from the sensing process provides a profile of the presence of the conductive object to the sensing device in each dimension. Alternatively, other methods for scanning known by those of ordinary skill in the art may be used to scan the sensing device.

Digital counter 440 is coupled to the output of the relaxation oscillator 450. Digital counter 440 receives the relaxation oscillator output signal 456 (F_{OUT}). Digital counter 440 is configured to count at least one of a frequency or a period of the relaxation oscillator output received from the relaxation oscillator.

As previously described with respect to the relaxation oscillator 450, when a finger or conductive object is placed on the sensor element, the capacitance increases from Cp to Cp+Cf so the relaxation oscillator output signal 456 (F_{OUT}) decreases. The relaxation oscillator output signal 356 (F_{OUT}) is fed to the digital counter 440 for measurement. There are two methods for counting the relaxation oscillator output signal 456, frequency measurement and period measurement. In one embodiment, the digital counter 440 may include two multiplexers 423 and 424. Multiplexers 423 and 424 are configured to select the inputs for the PWM 421 and the timer 422 for the two measurement methods, frequency and period measurement methods. Alternatively, other selection circuits may be used to select the inputs for the PWM 421 and the time 422. In another embodiment, multiplexers 423 and 424 are not included in the digital counter, for example, the digital counter 440 may be configured in one, or the other, measurement configuration.

In the frequency measurement method, the relaxation oscillator output signal 356 is counted for a fixed period of time. The counter 422 is read to obtain the number of counts during the gate time. This method works well at low frequencies where the oscillator reset time is small compared to the oscillator period. A pulse width modulator (PWM) 441 is clocked for a fixed period by a derivative of the system clock, VC3 426 (which is a divider from system clock 425, e.g., 24 MHz). Pulse width modulation is a modulation technique that generates variable-length pulses to represent the amplitude of an analog input signal; in this case VC3 426. The output of PWM 421 enables timer 422 (e.g., 16-bit). The relaxation oscillator output signal 456 clocks the timer 422. The timer 422 is reset at the start of the sequence, and the count value is read out at the end of the gate period.

In the period measurement method, the relaxation oscillator output signal 356 gates a counter 422, which is clocked by the system clock 425 (e.g., 24 MHz). In order to improve sensitivity and resolution, multiple periods of the oscillator are counted with the PWM 421. The output of PWM 421 is used to gate the timer 422. In this method, the relaxation oscillator output signal 356 drives the clock input of PWM 421. As previously described, pulse width modulation is a modulation technique that generates variable-length pulses to represent the amplitude of an analog input signal; in this case the relaxation oscillator output signal 456. The output of the PWM 421 enables timer 422 (e.g., 16-bit), which is clocked at the system clock frequency 425 (e.g., 24 MHz). When the output of PWM 421 is asserted (e.g., goes high), the count starts by releasing the capture control. When the terminal count of the PWM 421 is reached, the capture signal is asserted (e.g., goes high), stopping the count and setting the PWM's interrupt. The timer value is read in this interrupt. The relaxation oscillator 450 is indexed to the next sensor element to be measured and the count sequence is started again.

The two counting methods may have equivalent performance in sensitivity and signal-to-noise ratio (SNR). The period measurement method may have a slightly faster data acquisition rate, but this rate is dependent on software loads and the values of the capacitances on the sensor elements. The frequency measurement method has a fixed-sensor element data acquisition rate.

The length of the counter 422 and the detection time required for the sensor element are determined by sensitivity requirements. Small changes in the capacitance on capacitor 351 result in small changes in frequency. In order to find these small changes, it may be necessary to count for a considerable time.

Using the selection circuit 430, multiple sensor elements may be sequentially scanned to provide current to and measure the capacitance from the capacitors (e.g., sensor elements), as previously described. In other words, while one sensor element is being measured, the remaining sensor elements are grounded. The capacitor charging current (e.g., current source 452) and reset switch 453 are connected to the analog mux bus 411. This may limit the pin-count requirement to simply the number of sensor elements to be addressed. In one exemplary embodiment, no external resistors or capacitors are required inside or outside the processing device 210 to enable operation.

FIGS. 5C and 5D illustrate top-side and side views of one embodiment of a two-layer touch-sensor pad. Touch-sensor pad, as illustrated in FIGS. 5C and 5D, include the first two columns 505(1) and 505(2), and the first four rows 504(1)-504(4) of sensor array 500. The sensor elements of the first column 501(1) are connected together in the top conductive layer 575, illustrated as hashed hexagonal sensor elements and connections. The hexagonal sensor elements of each column, in effect, form a chain of elements. The sensor elements of the second column 501(2) are similarly connected in the top conductive layer 575. The sensor elements of the first row 504(1) are connected together in the bottom conductive layer 575 using vias 577, illustrated as hexagonal diamond sensor elements and connections. The hexagonal sensor elements of each row, in effect, form a chain of elements. The sensor elements of the second, third, and fourth rows 504(2)-504(4) are similarly connected in the bottom conductive layer 576.

In one embodiment, the hexagonal sensor elements are connected on one axis by conductive traces residing on the same layer, and the other axis utilizes vias through the printed circuit board (PCB) substrate to connect the hexagonal sensor elements. As illustrated in FIG. 5D, the top conductive layer 575 includes the sensor elements for both the columns and the rows of the sensor array, as well as the conductive trace connections between the sensor elements of the columns of the sensor array. In one embodiment, sensor elements, vias, and interconnection traces may be made from conductive materials, for example, a metal (e.g., copper) or a transparent conductive material such as indium tin oxide (ITO). Alternatively, other conductive materials may be used.

The bottom conductive layer 576 includes the conductive paths that connect the sensor elements of the rows that reside in the top conductive layer 575. The conductive paths between the sensor elements of the rows use vias 577 to connect to one another in the bottom conductive layer 576. Vias 577 go from the top conductive layer 575, through the dielectric, non-conductive, substrate 578, to the bottom conductive layer 576. Coating layers 579 and 589 are applied to the surfaces opposite to the surfaces that are coupled to the substrate 578 on both the top and bottom conductive layers 575 and 576.

It should be noted that the space between coating layers 579 and 589 and substrate 578, which does not include any conductive material, may be filled with the same material as the coating layers or dielectric layer. Alternatively, it may be filled with other materials.

It should be noted that the present embodiments are not be limited to connecting the sensor elements of the rows using vias to the bottom conductive layer 576, but may include connecting the sensor elements of the columns using vias to the bottom conductive layer 576. Moreover the sensor elements need not reside on a same layer. Rather, the row sensor elements may reside on a different layer than the column sensor elements. Furthermore, the present embodiments are not limited to the two-layer board configuration described, but may manufactured using other 2 layer constructs or other layer structures (e.g., three and four layer board constructs).

The substrate 578 may be made of materials such as FR4 or Kapton™ (e.g., flexible PCB). Alternatively, other materials may be used for the substrate 578. The processing device 210 may be attached (e.g., soldered) directly to the sensing PCB (e.g., attached to the non-sensing side of the PCB). The PCB thickness varies depending on multiple variables, including height restrictions and sensitivity requirements. In one embodiment, the PCB thickness is at least approximately 0.3 millimeters (mm). Alternatively, the PCB may have other thicknesses. It should be noted that thicker PCBs may yield better results. The PCB length and width is dependent on individual design requirements for the device on which the sensing device is mounted, such as a notebook or mobile handset.

The adhesive layer is directly on top of the PCB sensing array and is used to affix the overlay to the overall touchpad assembly. Typical material used for connecting the overlay to the PCB is non-conductive adhesive such as 3M 467 or 468. In one exemplary embodiment, the adhesive thickness is approximately 0.05 mm. Alternatively, other thicknesses may be used. The overlay may be ABS plastic, polycarbonate, glass, or Mylar™. Alternatively, other materials known by those of ordinary skill in the art may be used.

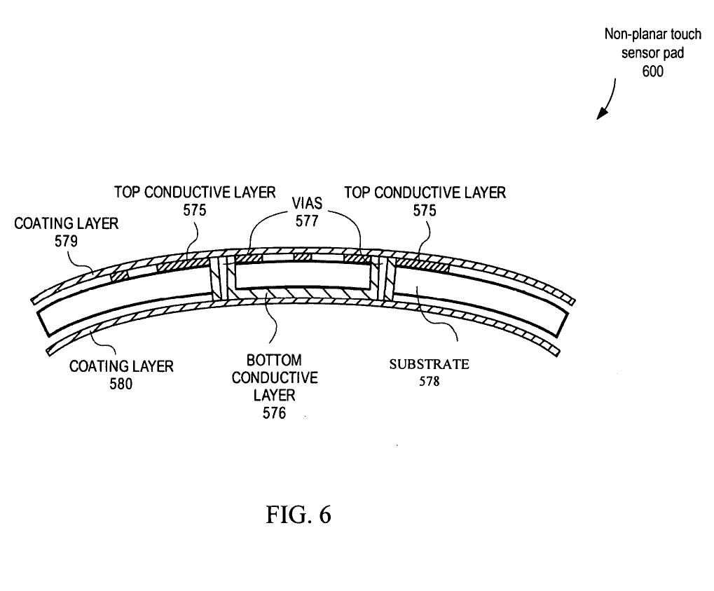

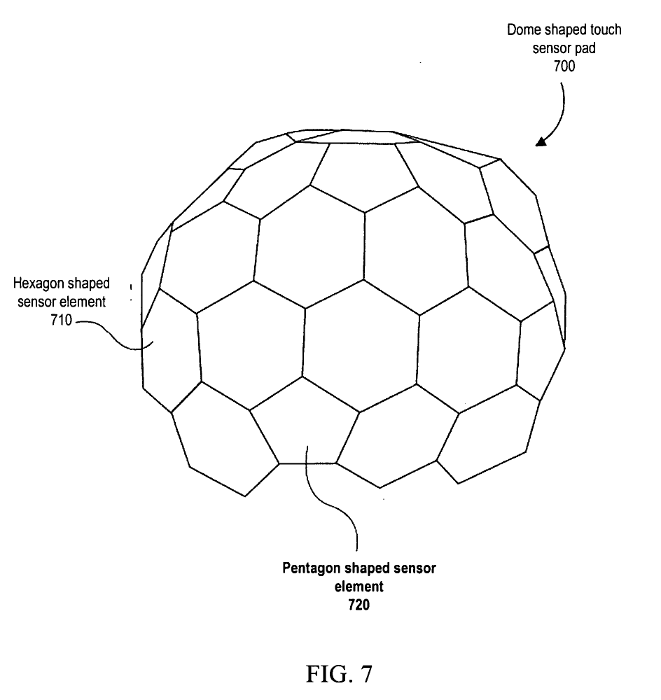

FIG. 6 is a cross-sectional view illustrating a non-planar touch sensor pad according to an alternative embodiment of the present invention. In one embodiment, the non-planar touch sensor pad may be constructed with one or more non-planar layers. In the exemplary embodiment illustrated in FIG. 6, all of the layers of non-planer touch sensor pad 600 are non-planar. In such an embodiment, the substrate 578 is fabricated from a flexible material such as Kapton™ or flexible PCB (FPCB). A non-planer touch sensor pad may have various shapes, for example, a dome shape as illustrated in FIG. 7.

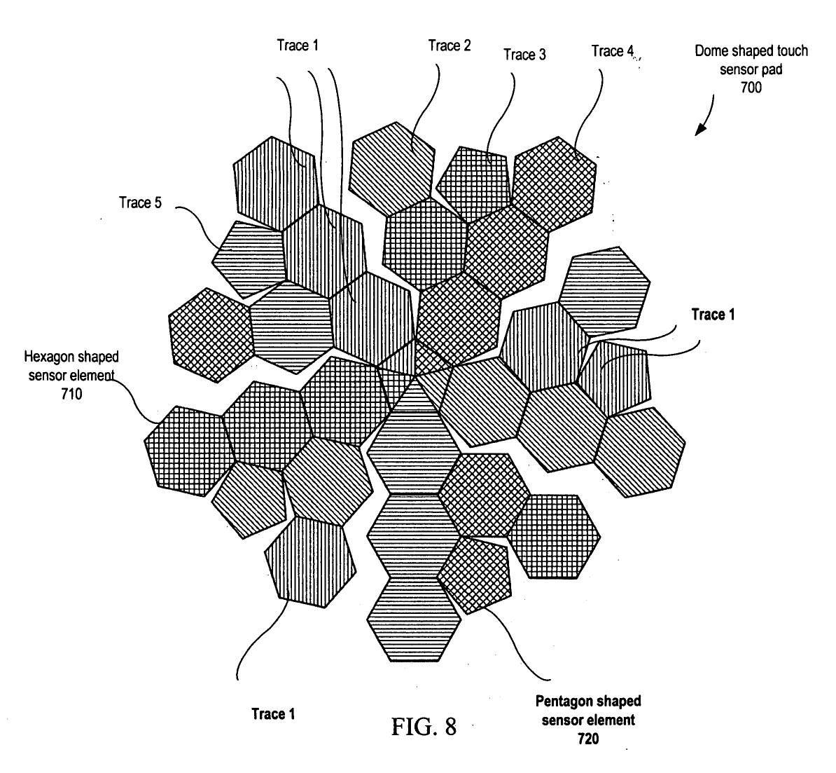

FIG. 7 is a perspective view illustrating a dome-shaped touch sensor pad. In this embodiment, touch sensor pad 700 has a dome shape that is formed with non-planar sensor elements. In one embodiment, combinations of hexagon shaped sensor elements (e.g., sensor element 710) and pentagon shaped sensor elements (e.g., sensor element 720) can be used to create such a dome shaped touch sensor pad. Using hexagon and pentagon shaped sensor elements, a generally uniform touch sensor surface that adapts to a non-planar surface may be constructed. More specifically, the use of sensor elements having polygon shapes of five or more sides may allow for greater packing efficiency of the sensor elements on the touch sensor pad. The use of a pentagon shaped sensor elements (e.g., sensor element 710) may be of particular advantage in combination with hexagon shaped sensor elements with touch sensor pads having a dome profile as illustrated in FIG. 7 in order to avoid significant gaps between the sensor elements. It should be noted that both FIG. 7 and FIG. 8 are conceptual illustrations having sensor elements in contact with each other intended to show the packing efficiency of the hexagon and pentagon shapes. In actual implementation, the sides of the sensor elements do not contact each other but, rather, are spaced apart from each other as discussed above in relation to FIG. 4A.

FIG. 8 is a two dimensional view illustrating the sensor elements of the dome-shaped touch sensor pad of FIG. 7 according to one embodiment of the present invention. The view shown in FIG. 8 is a view where the sensor elements have been conceptually planarized as if placed in on a two dimensional surface. In this embodiment, the sensor elements of similar hatching are electrically coupled together. Each type of hatching corresponds to a series of electrically coupled sensor elements or “traces.” In the illustrated embodiment, for example, includes five electrodes: trace 1 having vertical hatching; trace 2 having diagonal hatching; trace 3 having vertical/horizontal cross-hatching; trace 4 having the diagonal cross-hatching; trace 5 having the horizontal hatching. In this exemplary embodiment, each of the electrodes has six sensor elements. Alternatively, each of the electrodes may have more or less than 6 sensor elements depending on the size and shape of the touch sensor pad.

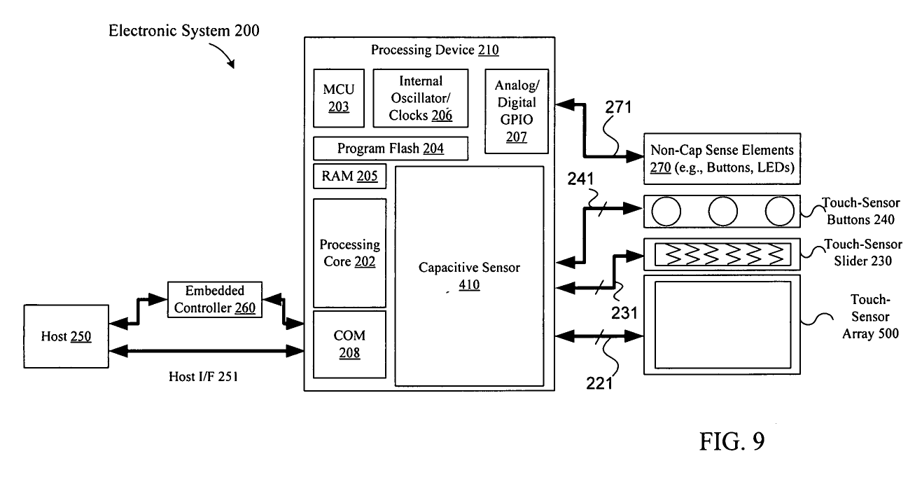

Placing a conductive object on (or in close proximity to) the touch pad electrodes increases the capacitance of the trace to ground. Placing a conductive object over more than one of the electrodes (i.e., sensor element of similar hatching in FIG. 8), allows the sensing components (e.g., in processing device 210 of FIG. 9) to determine conductive object position over the non-planar touch sensor pad. Each location on the non-planar touch sensor pad 700 will have a different capacitance signature when the conductive object is placed on the sensing traces. In one embodiment, each sensor trace diverges at least twice to have positions in the sensor pad 700 in more than one location. Such a configuration may help to create the individual signatures for each location on the touch sensor pad surface. Hardware, firmware, software or a combination thereof in the processing device is used to interpret the different capacitance signals and determine where the conductive object is on the non-planar touch sensor pad surface using techniques known in the art.

It should be noted that the hexagon shaped sensor elements and the pentagon shaped sensor elements may also be utilized with planar touch sensor pads. It should also be noted that the non-planar touch sensor pads may also utilize sensor elements having shapes other than polygon shapes. In addition, with either planar or non-planar touch sensor pads, the coordinates for the sensor elements may be associated with a Cartesian coordinate system (e.g., x-axis and y-axis coordinates), a polar coordinate system (e.g., r and theta), or another type of coordinate system. An alternative coordinate system may be used, for example, by assigning three to the sensing surface. In such an embodiment, each sensor location has a slightly different capacitance signature based on its neighbors. For example, with the touch sensor pad illustrated in FIG. 8, the hexagon shaped sensor elements may be larger than the pentagon shaped sensor elements and, hence, produce a different capacitance signal.

In one embodiment, the surface coordinate position of the presence of the conductive object on a spherical interface is determined in the same way a position on a globe is determined; the angle along the surface from horizontal center of the sphere and angle from some arbitrary longitudinal reference may be determined to give coordinates of the position. This may be implemented in a full or partial sphere. In another embodiment, the spherical interface is a half sphere (as shown in FIG. 7), and one of the constant traces (of which there are 5) is chosen as the longitudinal center. Each of the other four represents 72 degree shifts (positive or negative) from the center point. The latitude is output as a position along the longitudinal line (in degrees or radians). Alternatively, other methods for determining a surface coordinate position of the conductive object on a spherical interface may be used as known by those of ordinary skill in the art.

FIG. 9 illustrates a block diagram of one embodiment of an electronic system having a processing device and a touch-sensor pad for detecting a presence of a conductive object according to one embodiment of the present invention. Electronic system 200 includes processing device 210, touch-sensor pad 220, touch-sensor slider 230, touch-sensor buttons 240, host processor 250, embedded controller 260, and non-capacitive sensor elements 270. The processing device 210 may include analog and/or digital general purpose input/output (“GPIO”) ports 207. GPIO ports 207 may be programmable. GPIO ports 207 may be coupled to a Programmable Interconnect and Logic (“PIL”), which acts as interconnect between GPIO ports 207 and a digital block array of the processing device 210 (not illustrated). The digital block array may be configured to implement a variety of digital logic circuits (e.g., DAC, digital filters, digital control systems, etc.) using, in one embodiment, configurable user modules (“UMs”). The digital block array may be coupled to a system bus. Processing device 210 may also include memory, such as random access memory (RAM) 205 and program flash 204. RAM 205 may be static RAM (SRAM), and program flash 204 may be a non-volatile storage, which may be used to store firmware (e.g., control algorithms executable by processing core 202 to implement operations described herein). Processing device 210 may also include a memory controller unit (MCU) 203 coupled to memory and the processing core 202.

The processing device 210 may also include an analog block array (not illustrated). The analog block array is also coupled to the system bus. Analog block array also may be configured to implement a variety of analog circuits (e.g., ADC, analog filters, etc.) using, in one embodiment, configurable UMs. The analog block array may also be coupled to the GPIO 207.

As illustrated, capacitive sensor 410 may be integrated into processing device 210. Capacitive sensor 410 may include analog I/O for coupling to an external component, such as touch-sensor pad 220, touch-sensor slider 230, touch-sensor buttons 240, and/or other devices. Capacitive sensor 410 and processing device 202 are described in more detail below.

It should be noted that the embodiments described herein are not limited to touch-sensor pads for notebook implementations, but can be used in other capacitive sensing implementations, for example, the sensing device may be a touch-sensor slider 230, or a touch-sensor button 240 (e.g., capacitance sensing button). Similarly, the operations described herein are not limited to notebook pointer operations, but can include other operations, such as lighting control (dimmer), volume control, graphic equalizer control, speed control, or other control operations requiring gradual or discrete adjustments. It should also be noted that these embodiments of capacitive sensing implementations may be used in conjunction with non-capacitive sensing elements, including but not limited to pick buttons, sliders (ex. display brightness and contrast), scroll-wheels, multi-media control (ex. volume, track advance, etc) handwriting recognition and numeric keypad operation.

In one embodiment, the electronic system 200 includes a touch-sensor pad 220 coupled to the processing device 210 via bus 221. Touch-sensor pad 220 may include a multi-dimension sensor array. The multi-dimension sensor array comprises a plurality of sensor elements, organized as rows and columns. In another embodiment, the electronic system 200 includes a touch-sensor slider 230 coupled to the processing device 210 via bus 231. Touch-sensor slider 230 may include a single-dimension sensor array. The single-dimension sensor array comprises a plurality of sensor elements, organized as rows, or alternatively, as columns. In another embodiment, the electronic system 200 includes a touch-sensor button 240 coupled to the processing device 210 via bus 241. Touch-sensor button 240 may include a single-dimension or multi-dimension sensor array. The single- or multi-dimension sensor array comprises a plurality of sensor elements. For a touch-sensor button, the plurality of sensor elements may be coupled together to detect a presence of a conductive object over the entire surface of the sensing device. Alternatively, the touch-sensor button 240 has a single sensor element to detect the presence of the conductive object. In one embodiment, the touch-sensor button 240 may be a capacitive sensor element. Capacitive sensor elements may be used as non-contact sensor elements. These sensor elements, when protected by an insulating layer, offer resistance to severe environments.

The electronic system 200 may include any combination of one or more of the touch-sensor pad 220, touch-sensor slider 230, and/or touch-sensor button 240. In another embodiment, the electronic system 200 may also include non-capacitive sensor elements 270 coupled to the processing device 210 via bus 271. The non-capacitive sensor elements 270 may include buttons, light emitting diodes (LEDs), and other user interface devices, such as a mouse, a keyboard, or other functional keys that do not require capacitance sensing. In one embodiment, buses 271, 241, 231, and 221 may be a single bus. Alternatively, these buses may be configured into any combination of one or more separate buses.

The processing device may also provide value-added functionality such as keyboard control integration, LEDs, battery charger and general purpose I/O, as illustrated as non-capacitive sensor elements 270. Non-capacitive sensor elements 270 are coupled to the GPIO 207.

Processing device 210 may include internal oscillator/clocks 206 and communication block 208. The oscillator/clocks block 206 provides clock signals to one or more of the components of processing device 210. Communication block 208 may be used to communicate with an external component, such as a host processor 250, via host interface (I/F) line 251. Alternatively, processing block 210 may also be coupled to embedded controller 260 to communicate with the external components, such as host 250. Interfacing to the host 250 can be through various methods. In one exemplary embodiment, interfacing with the host 250 may be done using a standard PS/2 interface to connect to an embedded controller 260, which in turn sends data to the host 250 via low pin count (LPC) interface. In some instances, it may be beneficial for the processing device 210 to do both touch-sensor pad and keyboard control operations, thereby freeing up the embedded controller 260 for other housekeeping functions. In another exemplary embodiment, interfacing may be done using a universal serial bus (USB) interface directly coupled to the host 250 via host interface line 251. Alternatively, the processing device 210 may communicate to external components, such as the host 250 using industry standard interfaces, such as USB, PS/2, inter-integrated circuit (I2C) bus, or system packet interfaces (SPI). The host 250 and/or embedded controller 260 may be coupled to the processing device 210 with a ribbon or flex cable from an assembly, which houses the sensing device and processing device.

In one embodiment, the processing device 210 is configured to communicate with the embedded controller 260 or the host 250 to send and/or receive data. The data may be a command or alternatively a signal. In an exemplary embodiment, the electronic system 200 may operate in both standard-mouse compatible and enhanced modes. The standard-mouse compatible mode utilizes the HID class drivers already built into the Operating System (OS) software of host 250. These drivers enable the processing device 210 and sensing device to operate as a standard pointer control user interface device, such as a two-button PS/2 mouse. The enhanced mode may enable additional features such as scrolling (reporting absolute position) or disabling the sensing device, such as when a mouse is plugged into the notebook. Alternatively, the processing device 210 may be configured to communicate with the embedded controller 260 or the host 250, using non-OS drivers, such as dedicated touch-sensor pad drivers, or other drivers known by those of ordinary skill in the art.

In other words, the processing device 210 may operate to communicate data (e.g., commands or signals) using hardware, software, and/or firmware, and the data may be communicated directly to the processing device of the host 250, such as a host processor, or alternatively, may be communicated to the host 250 via drivers of the host 250, such as OS drivers, or other non-OS drivers. It should also be noted that the host 250 may directly communicate with the processing device 210 via host interface 251.

In one embodiment, the data sent to the host 250 from the processing device 210 includes click, double-click, movement of the pointer, scroll-up, scroll-down, scroll-left, scroll-right, step Back, and step Forward. Alternatively, other user interface device commands may be communicated to the host 250 from the processing device 210. These commands may be based on gestures occurring on the sensing device that are recognized by the processing device, such as tap, push, hop, and zigzag gestures. Alternatively, other commands may be recognized. Similarly, signals may be sent that indicate the recognition of these operations.

In particular, a tap gesture, for example, may be when the finger (e.g., conductive object) is on the sensing device for less than a threshold time. If the time the finger is placed on the touchpad is greater than the threshold time it may be considered to be a movement of the pointer, in the x- or y-axes. Scroll-up, scroll-down, scroll-left, and scroll-right, step back, and step-forward may be detected when the absolute position of the conductive object is within a pre-defined area, and movement of the conductive object is detected. Alternatively, the tap gesture may be recognized using other techniques, such as detecting a presence of a conductive object on a sensing device, determining a velocity of the detected presence of the conductive object, and recognizing a tap gesture based on the velocity.

Processing device 210 may reside on a common carrier substrate such as, for example, an integrated circuit (IC) die substrate, a multi-chip module substrate, or the like. Alternatively, the components of processing device 210 may be one or more separate integrated circuits and/or discrete components. In one exemplary embodiment, processing device 210 may be a Programmable System on a Chip (PSoC™) processing device, manufactured by Cypress Semiconductor Corporation, San Jose, Calif. Alternatively, processing device 210 may be one or more other processing devices known by those of ordinary skill in the art, such as a microprocessor or central processing unit, a controller, special-purpose processor, digital signal processor (DSP), an application specific integrated circuit (ASIC), a field programmable gate array (FPGA), or the like. In an alternative embodiment, for example, the processing device may be a network processor having multiple processors including a core unit and multiple microengines. Additionally, the processing device may include any combination of general-purpose processing device(s) and special-purpose processing device(s).

Capacitive sensor 410 may be integrated into the IC of the processing device 210, or alternatively, in a separate IC. Alternatively, descriptions of capacitive sensor 410 may be generated and compiled for incorporation into other integrated circuits. For example, behavioral level code describing capacitive sensor 410, or portions thereof, may be generated using a hardware descriptive language, such as VHDL or Verilog, and stored to a machine-accessible medium (e.g., CD-ROM, hard disk, floppy disk, etc.). Furthermore, the behavioral level code can be compiled into register transfer level (“RTL”) code, a netlist, or even a circuit layout and stored to a machine-accessible medium. The behavioral level code, the RTL code, the netlist, and the circuit layout all represent various levels of abstraction to describe capacitive sensor 410.

It should be noted that the components of electronic system 200 may include all the components described above. Alternatively, electronic system 200 may include only some of the components described above.

In one embodiment, electronic system 200 may be used in a notebook computer. Alternatively, the electronic device may be used in other applications, such as a mobile handset, a personal data assistant (PDA), a keyboard, a television, a remote control, a monitor, a handheld multi-media device, a handheld video player, a handheld gaming device, or a control panel.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

What is claimed is:

1. An apparatus, comprising:
a touch sensing array having a plurality of sensor elements to detect a presence of a conductive object on the touch sensing array, wherein one or more of the plurality of sensor elements has a first polygon shape having five or more sides.

2. The apparatus of claim, 1, wherein the first polygon shape having five or more sides is a hexagon shape.

3. The apparatus of claim 2, wherein each of the plurality of sensor elements has the hexagon shape.

4. The apparatus of claim 3, wherein each of the plurality of sensor element have the hexagon shape to increase a vertical capacitance of each of the sensor elements to the conductive object while not increasing a fringe capacitance of each of the plurality of sensor elements to each other.

5. The apparatus of claim 1, wherein the first polygon shape having five or more sides is a pentagon shape.

6. The apparatus of claim 1, wherein another one or more of the plurality of sensor elements has a second polygon shape having five or more sides.

7. The apparatus of claim, 6, wherein the first polygon shape having five or more sides is a hexagon shape and wherein the second polygon shape having five or more sides is a pentagon shape.

8. The apparatus of claim 6, wherein the hexagon shaped sensor elements are configured to increase a vertical capacitance of each of the sensor elements to the conductive object while not increasing a fringe capacitance of the plurality of sensor elements to each other.

9. The apparatus of claim 1, wherein the touch sensing array is non-planar.

10. The apparatus of claim 1, wherein the plurality of sensor elements is fabricated from indium tin oxide.

11. An apparatus, comprising:
a sensor array having a plurality of sensor elements to detect a presence of a conductive object on the sensor array, wherein the plurality of sensor elements have a polygon shape to increase a vertical capacitance of each of the sensor elements to the conductive object while not increasing a fringe capacitance of the plurality of sensor elements to each other.

12. The apparatus of claim 11, wherein the vertical capacitance is equal to an area of the polygon shape of one sensor element times a dielectric property of an insulator layer between the one sensor element and the conductive object divided by the distance between the one sensor element and the conductive object 13.

13. The apparatus of claim 12, wherein the polygon has five or more sides.

14. The apparatus of claim 13, wherein one or more of the plurality of sensor elements have a hexagonal shape.

15. The apparatus of claim 13, wherein one or more of the plurality of sensor elements have a pentagon shape.

16. The apparatus of claim 13, wherein a first group of the plurality of sensor elements has a hexagon shape and a second group of the plurality of sensor elements has a hexagon shape.

17. An apparatus, comprising:
a processing device; and
a sensor array coupled to the processing device, the sensor array having a plurality of sensor elements to detect a presence of a conductive object on the sensor array, the sensing array comprising means for increasing a vertical capacitance of each of the sensor elements to the conductive object while not increasing a fringe capacitance of the plurality of sensor elements to each other.

18. A method, comprising:
providing a sensing array having a plurality of sensor elements, wherein one or more of the plurality of sensor elements has a first polygon shape having five or more sides; and
detecting a presence of a conductive object on at least one of the plurality of sensor elements.

19. The method of claim 18, wherein another one or more of the plurality of sensor elements has a second polygon shape having five or more sides.

20. The method of claim 18, wherein the first polygon shape is a hexagon shape, and wherein the second polygon shape is a pentagon shape.
